(19) United States
(12) Patent Application Publication
(10) Pub. No.: US 2015/0193838 A1
(43) Pub. Date: Jul. 9, 2015

(54) REAL CHARITY

(71) Applicant: Linda G. Ramsden, Wellesley, MA (US)

(72) Inventor: Linda G. Ramsden, Wellesley, MA (US)

(21) Appl. No.: 14/147,783

(22) Filed: Jan. 6, 2014

(51) Int. Cl. G06Q 30/02

(52) U.S. Cl. CPC G06Q 30/0279; G06Q 30/0214; G06Q 30/0273

(57) ABSTRACT

REAL CHARITY is a new business method for distributing commissions on real estate transactions whereby twenty to fifty percent of said commission is directed to a non-profit organization of buyer or seller's election, for which the buyer or seller receives a tax receipt/tax benefit.

### CROSS-REFERENCE TO RELATED APPLICATIONS

Not Applicable

### BACKGROUND OF THE INVENTION

REAL CHARITY is a new business method of conducting for-profit real estate transactions while fundraising for nonprofit organizations. It can best be described as a creative business solution which finds its roots in both real estate markets and charitable giving. With the recent growth in nonprofit organizations, and the attendant charitable giving that such organizations solicit, there is a corresponding fatigue that threatens the sustainability of charitable organizations. REAL CHARITY solves this problem by identifying a previously untapped source of revenue for local charities—Real Estate Commissions. Currently, buyers and sellers of real estate pay a standard commission rate of five to seven percent to the brokers that have represented them in their transactions. REAL CHARITY assists these buyers and sellers in making a sizeable donation to charity, for which the buyer or seller will receive full benefit for tax purposes.

REAL CHARITY was born of the Inventor's personal experience with both the real estate and non-profit sectors. For the past twenty years, the Inventor has bought and sold real estate in the Commonwealth of Massachusetts. She has extensive experience in renovating and re-selling both primary and secondary homes. Then, in 2005, her son died of pediatric cancer and she changed her focus to fundraising to help other families of pediatric cancer. She created a successful nonprofit and learned of the difficulties of fundraising in an overly-saturated marketplace. Even with a cause of tremendous personal appeal, each donation was hard won and she started thinking about a better way. She identified that the best fundraising tools had three common elements: First, there is a quid pro quo element where the donation is given in exchange for a good or service of use; second, the focus is on an already-existing activity, i.e. the solicitor is not asking the donor to do something they weren't otherwise doing; and lastly, the donor is primarily motivated to give to a cause that they self-elect i.e. the element of choice is significant. With these things in mind, and having paid in excess of $100,000 in broker's fees in just two moves in 2011, the Inventor began formulating the business model presented herein. She saw that similar models were working with local art consortiums that were being run as not-for-profit organizations. She also discovered that the biggest drawback to that commodity (art) was that the donor was unable to claim a deduction other than by submitting that they had paid more than the art was worth. This point in particular is what attracted the Inventor to the commodity of real estate services. The industry standard, particularly in affluent markets, was already non-commensurate with services rendered. For instance, a 5% commission on a million dollar property, which is the average home price in the Inventor's community, yields a brokerage fee of $50,000. With discount brokerage firms charging flat fees of $ 10,000, there is a substantial amount of revenue that is clearly in excess of the home service that was received.

Through this analysis, not only was the quid pro quo requirement present, it appeared that real estate services was a uniquely appropriate stream of revenue on which to focus, because there was an acceptable ‘extra’ bit of money for the donor, in this case the REAL CHARITY buyer or seller, to direct to charity and still receive a tax benefit. The second element, that the fundraising be focused on an already-existing activity, also makes real estate services a unique match. Buying and selling homes is probably one of the few things that remain a constant through both strong and poor economies. Either economy provides the necessity, ability or impetus to move. Traditional fundraising suffers in a poor economy, as the Inventor is well aware. As someone who has professionally fundraised for the past five years, the Inventor sees REAL CHARITY as a real game-changer for nonprofits. What an incredible opportunity for all of those professionals who currently devote most of their time to fundraising activities when they could instead be engaged in the important work of their mission. And how nice would it be for the general public to not have to worry about being nickeled and dimed every time they went to the market or attended a PTO meeting? With a healthy and viable stream of revenue available to fund local organizational activities, people can feel free to once again relate to their neighbors and townsmen without constant agenda. Lastly, the element of choice is significant in the REAL CHARITY transaction. Aside from estate planning, when else is a consumer able to make a meaningful and sizeable gift to charity? For that reason, it is important that the consumer be able to make an election that is personal to them. That said, each REAL CHARITY brokerage may determine that different percentages apply to different charities. For instance, a REAL CHARITY brokerage will develop relationships with certain local charities and become familiar with their mission. For that reason, they may make a list of those charities available to a buyer or seller and assist that buyer or seller in directing one third (33%) of the commission to one of those charities. Should the buyer or seller have another 501(c)(3) charity in mind that is not on the list, the REAL CHARITY broker would be required to confirm that charity's status and there would be some extra legwork involved that might lead the broker to determine that only one quarter (25%) of the commission could be directed to a charity that has not been previously approved. These are business decisions that can be left to each broker conducting a REAL CHARITY transaction. As long as the broker is assisting the consumer in directing between twenty and fifty percent to charity, it remains a REAL CHARITY transaction.

### BRIEF SUMMARY OF THE INVENTION

REAL CHARITY=Real Estate Commissions as Contributions to Charity

REAL CHARITY is a new business method for distributing commissions on real estate transactions whereby twenty to fifty percent of said commission is directed to a non-profit organization of buyer or seller's election, for which the buyer or seller receives a tax receipt/tax benefit.

### BRIEF DESCRIPTION OF SEVERAL VIEWS OF THE INVENTION

Not Applicable

### DETAILED DESCRIPTION OF THE INVENTION

In a real estate transaction that employs the REAL CHARITY model a buyer or seller will elect in the Agency Representation Agreement to pay 20-50% of the commission directly to a charity of their choice. The balance of the commission is paid to their agent/broker for their representation. The amount that is paid directly to charity will be stated as such on the HUD statement and the buyer or seller who has made the REAL CHARITY election will receive a tax receipt for their charitable donation and receive the attendant tax benefit for said donation.

For example: Ms. Owner decides to sell her real property. She contacts a REAL CHARITY broker and learns that, according to that broker's use of the REAL CHARITY model she may elect to pay 30% of the commission to a charity of her choice. She signs an Agency Representation Agreement which includes language to this effect, and transforms this commission structure into a contractual agreement. It is important to note that Ms. Owner is not paying any less of her commission share, she is simply structuring her commission payment so that she can both compensate her agent/broker for their representation and make a meaningful donation to charity. Ms. Owner's property sells for $800,000 in a market where the standard real estate commission is 5%, or $40,000. Mr. Buyer's agent collects $20,000 for their 2.5% share of the commission, while Ms, Owner's agent collects $14,000 and a donation of $6,000 is paid to a charity of Ms. Owner's choice. The HUD statement and/or other closing documents will have had the following notation with respect to commissions: 2.5% to Buyer's Agent; 1.75% to Sellers Agent; 0.75% payable from Ms. Owner to Charity. Ms. Owner receives a tax receipt for her donation. (Note: Had Mr. Buyer also contacted a REAL CHARITY broker to represent him, he could have elected a similar split-structured commission and received a tax benefit for his donation.)

Currently, real estate brokers who wish to distinguish themselves through their philanthropy will make charitable donations and receive the tax benefit associated with those donations. For instance, an industry leader contributes $10 for every transaction. The office conducts forty transactions each year, so $400 is given to a charity of the broker's choice and the broker is issued a tax receipt. With the same forty transactions, a REAL CHARITY brokerage in the same locate would have assisted consumers in directing over $300,000 to charities of the consumers' choice, for which the consumer would receive a tax benefit. The ability for buyers and sellers to make significant charitable donations during the course of their real property transaction is revolutionary. It will allow what is currently an excessive amount of commission to instead be spent on building stronger communities. A REAL CHARITY buyer might choose to support the local elementary school where her child will be attending. Another REAL CHARITY seller might support a local soup kitchen or homeless shelter. REAL CHARITY will allow for a redistributing of community resources at a very specific and opportune time: Daring the single largest financial transaction that most individuals will ever undertake. REAL CHARITY respects the weight of that transaction and acknowledges that buyers and sellers deserve more than just great service. They deserve the opportunity to make a difference. It's also good for brokers because they have the opportunity to differentiate themselves as real community partners for change, thereby winning more business and increasing their profits as well. It is this Inventor's hope that the REAL CHARITY model could even have an impact on the nature and tone of these transactions, perhaps making them less adversarial and self-interested. It's good for business, good for nonprofits, good for the consumer and good for the community. Beyond that, the benefits of the REAL CHARITY model are beautifully self-sustaining: The money starts in the homes, it is primarily given to local charities thereby building stronger communities, which causes home values to increase so that even more money can be given to charity.

The Inventor will make her business model available by selling REAL CHARITY franchises and collecting a royalty fee per transaction for the use of her invention. For brokers who wish to employ the REAL CHARITY model without becoming a REAL CHARITY brokerage, said brokers may simply pay a higher royalty fee per transaction and enjoy ad hoc use of the model.

1. The use of the term REAL CHARITY as it relates to real estate commissions as charitable contributions.

2. Any method for distributing commissions on real estate transactions whereby twenty to fifty percent of said commission is directed to a non-profit organization of buyer or seller's election, for which the buyer or seller receives a tax receipt or tax benefit.

3. Any real estate commission structure which allows clients to pay twenty to fifty percent of the commission to charity, or pays it on their behalf in exchange for some other advantage.

4. Any Real Estate Broker/Agency Representation Agreement, HUD Statement or Closing Document which creates a commission structure whereby twenty to fifty percent of the commission is directed to a non-profit organization, resulting in a tax receipt to buyer or seller.

5. Any marketing tool or advertising promotion by a real estate broker/agent that their office is a REAL CHARITY brokerage without having paid to the Inventor franchise fees, royalties, or both.

6. Using the name Giving Properties when conducting a real estate transaction in which any amount of the transactional fees are directed to a charitable organization.
